(19) United States
(12) Patent Application Publication
(10) Pub. No.: US 2022/0083951 A1
(43) Pub. Date: Mar. 17, 2022

(54) SYSTEM AND METHODS FOR GENERATING EMPLOYEE SCHEDULES

(71) Applicant: Schedule Bot, LLC, Chicago, IL (US)

(72) Inventors: Aaron Brager, Chicago, IL (US); David Huber, Chicago, IL (US)

(73) Assignee: Schedule Bot, LLC, Chicago, IL (US)

(21) Appl. No.: 17/024,414

(22) Filed: Sep. 17, 2020

(51) Int. Cl. G06Q 10/06; G06Q 10/04; G06Q 10/10; G06N 20/00

(52) U.S. Cl. CPC G06Q 10/063118; G06Q 10/04; G06Q 10/067; G06N 20/00; G06Q 10/063112; G06Q 10/105; G06Q 10/1093

(57) ABSTRACT

The present disclosure relates generally to a system and methods for reporting an employee schedule, and more particularly to a system and methods for dynamically optimizing and generating employee schedules. The system may analyze a request for an employee schedule including demand data corresponding to proposed duty periods for a specific duration. The demand data is partitioned, optimized and assembled to produce one or more weekly shift configurations. Employees are then assigned to duty periods of the weekly shift configurations and a fitness function is calculated based on one or more constraints and, based on the calculated fitness function, an optimized schedule is generated. Advantageously, the system is configured to automatically output an optimized schedule including a plurality of shifts for a plurality of employees, while minimizing the amount of employer oversight for the scheduling process.

### FIELD OF THE DISCLOSURE

The present disclosure relates generally to a system and methods for reporting an employee schedule, and more particularly to a system and methods for dynamically optimizing and generating employee schedules.

### BACKGROUND

A schedule generally refers to a series of things to be done or of events to occur at a particular time or period. Examples of commonly used schedules for plotting a task, resource, or human include Gantt charts, PERT charts, and resource plots. Gantt charts plot a list of tasks that may or may not depend on one another against time. PERT charts are intended to calculate the minimum time required to complete a complex project having distinct tasks. Another type of chart that is used is an employee shift schedule.

Managing employee schedules is a challenge in many industries, such as grocery stores, hair salons, medical clinics, and restaurants. When creating a schedule, it is important to consider the forecasted workload or demands as well as other objectives, such as an individual employee's preferences. Other scheduling considerations include regulations regarding minimum and maximum number of employee working hours during any given day or week, break rules and regulations, customer needs, and individual employee skills, availability and scheduling preferences.

The difficulty with preparing schedules is increased when the hours of operation are outside what is normally referred to as “business hours” that are considered to be 9 am to 5 pm. Accordingly, for employers having extended business hours, the term “shift” is often associated with a period of time that an employee works.

Over time, employers have developed a number of standardized shift patterns to address their requirements. These include a three-shift system; staggered days; twilight or evening shift patterns; DuPont 12-Hour rotating shift; seven-day eight-hour rotating shifts; and California roll shift schedule. Such shift patterns are static and often do not take into account employee preferences and the varying demands of the employer.

Also, many known management systems are used for scheduling employees. Such systems typically include a basic planning capability to enable a manager to forecast future workloads and employee requirements to service such loads. For example, these systems may include an “auto-schedule” feature for creating basic schedules from templates, which can then be edited. Such management systems often require a large amount of oversight from the employer and include errors that are time consuming to fix. Employee management systems that may dynamically change based on predefined constraints and/or preferences would provide a variety of advantages to the employer.

Other known methods for producing an employee schedule are based on Artificial Intelligence (“AI”). AI generally refers to applications that are used to solve problems that normally require human intelligence. A significant drawback of AI solutions is that they are difficult and time consuming to develop, train, and implement. Consequently, AI solutions are cost prohibitive for conventional workforce scheduling applications. Such solutions may also limit the speed and accuracy with which schedules are created.

Therefore, there is a need for a system and methods by which a schedule is dynamically optimized, generated, and reported based on employer demands and employee preferences that are not time consuming and limits or eliminates errors and that are configurable to provide employees access to scheduling information, while minimizing employer oversight. The present invention satisfies this long-felt need.

### SUMMARY

The present invention relates generally to a system and methods for reporting employee schedules, and more specifically to a system and methods that facilitate optimizing and generating employee schedules based on employer demands and employee preferences. Advantageously, the system may automatically output an optimized schedule including a plurality of duty periods (i.e., shifts) for a plurality of employees, while minimizing the amount of employer oversight for the scheduling process. Moreover, the system solves other various technical problems associated with prior systems for managing employee schedules.

In operation, the system may receive a request for optimizing a schedule via a user interface, such as a graphic user interface. The request may include demand data corresponding to proposed duty periods for a specific duration, such as a day, week, and/or month. The system may then partition the demand data to create daily shift configurations, such as for each day of the week. Each shift configuration includes one or more duty periods corresponding to a duration of time for a specific skill.

The system may optimize the daily shift configurations by evaluating a fitness function. The fitness function is used to calculate a fitness score for each daily shift configuration based on the demand data of the request. After a number of iterations, the system may select an optimized daily shift configurations having the greatest fitness. The system may then assemble the optimized daily shift configurations to produce one or more weekly shift configurations.

Once one or more weekly shift configurations are assembled, the system may produce a plurality of assignment sets. The assignment sets are created by randomly assigning one or more employees to the one or more duty periods of each weekly shift configuration. A fitness function is then calculated for each assignment set based on one or more constraints associated with each employee and the demand data. In certain embodiments, the system may access a database including employee and employer data corresponding to the demand.

The system may then generate an optimized schedule by performing a simulated annealing technique that iteratively alters each assignment set and evaluates the corresponding fitness function until a threshold is met. The threshold may be a number of iterations altering each assignment set, a desired fitness score for the schedule, and/or a minimum number of errors associated with the schedule. The optimized schedule may be output on a display device, such as via a scheduling application. The output may further include a report with notifications regarding warnings or errors associated with the optimized schedule.

In certain embodiments, the system is further operative to validate a format of the request. The validation process may ensure that the request is in a readable format for scheduling purposes. An example of an acceptable format for the data may include JSON (JavaScript Object Notation).

In certain embodiments, the system may cross-breed two or more shift configurations. Also, the system may alter each shift configuration by modifying a start or end time of the duty period, reassigning the duty period to a different day, and/or changing a skill type associated with the duty period.

In certain preferred embodiments, the system may perform a simulated annealing technique that iteratively alters each daily shift configuration and evaluates the corresponding fitness function. The fitness function may be represented as single digit, a decimal, a 64-bit base-2 format double-precision floating point, or combinations thereof.

While the invention is susceptible to various modifications and alternative forms, specific exemplary embodiments thereof have been shown by way of example in the drawings and have herein been described in detail. It should be understood, however, that there is no intent to limit the invention to the particular embodiments disclosed, but on the contrary, the intention is to cover all modifications, equivalents, and alternatives falling within the scope of the invention as defined by the appended claims.

### BRIEF DESCRIPTION OF THE DRAWINGS

FIG. 1 is a schematic diagram illustrating an operation of a system for reporting an optimized schedule;

FIG. 2 is a flow chart illustrating an exemplary operation a system for reporting an optimized schedule;

FIG. 3 is a flow chart illustrating an exemplary operation for accessing a knowledgebase of the system;

FIG. 4 is a flow chart illustrating an exemplary operating for producing one or more weekly shift configurations;

FIG. 5 is a flow chart illustrating an exemplary operation for optimizing the one or more weekly shift configurations;

FIG. 6 is a flow chart illustrating an exemplary operation for outputting an optimized schedule and report;

FIG. 7 is an exemplary user interface of a scheduling application of the system;

FIG. 8A is an exemplary user interface of a scheduling application of the system for entering employee preferences;

FIG. 8B is an exemplary user interface of a scheduling application of the system for entering time-off requests;

FIG. 8C is an exemplary user interface of a scheduling application of the system for entering long-term unavailability requests;

FIG. 9 is an exemplary computing system that may be used for implementation of all or a portion of the invention; and

FIG. 10 is an exemplary cloud computing system that may be used for implementation of all or a portion of the invention.

### DETAILED DESCRIPTION

The present disclosure relates generally to a system and methods for reporting an employee schedule, and more particularly to a system and methods for dynamically optimizing and generating employee schedules.

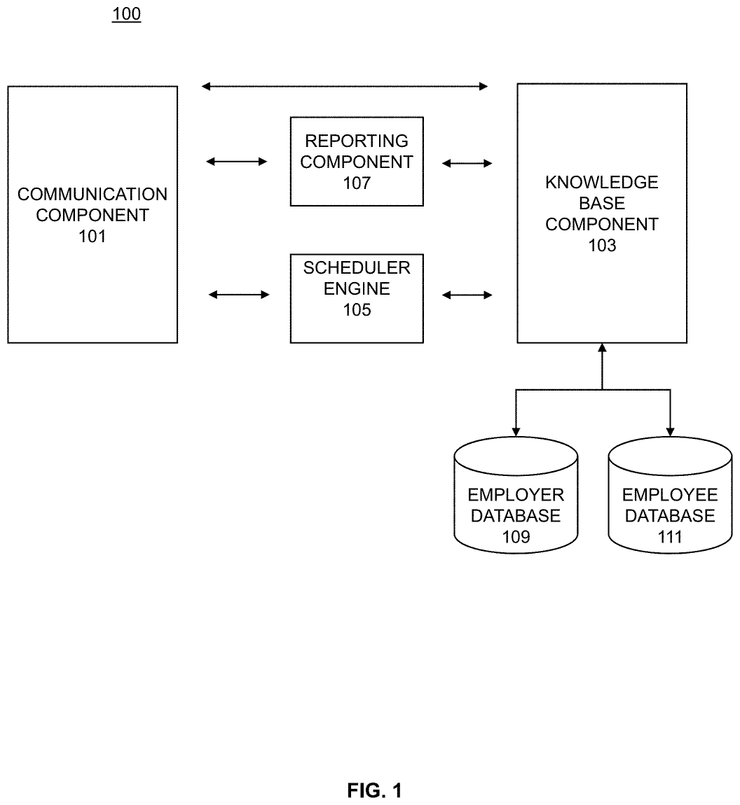

FIG. 1 illustrates an exemplary system 100 for reporting an optimized schedule according to one or more embodiments. The system 100 may include a communication component 101 that is configured to receive and analyze an input from one or more users. The communication component 101 interoperates with a knowledge base 103, a scheduling engine 105, and a reporting component 107 to generate and output the optimized schedule, as detailed below.

The input received by the communication component 101 may correspond to a request from a specific employer for an employee schedule. The request may include demand data corresponding to proposed duty periods for a specific skill and duration of time. The demand data may specify how many shifts within each day are to be scheduled, the type of skills needed for each shift, and the number of employees per scheduled shift. In certain embodiments, the demand data may further specify preferences for particular employees to work particular shifts, and various other constraints, such as avoiding overtime pay, grouping certain employees with certain other employees, and the like.

The knowledge base 103 provides access to information corresponding to the request. The information may be stored in an employer database 109 and/or an employee database 111. For example, the knowledge base 103 may access and/or maintain one or more employer profiles and one or more employee profiles. The employer profile may include general information about the respective employer, such as the location of the employer's business, the type of business, and items offered by the employer's business.

In addition, the employer database 109 may include shift schedules that have been used in the past by the particular employer, which particular employees worked which particular shifts, as well as the performance results of the shift, which may include employee hours worked during particular shifts, gratuities earned by each employee, revenue taken in by the employer for particular shifts, or other profitability information corresponding to particular shifts, and the like.

The employee database 111 may further include employee availability and preference information, which may indicate shifts for which the employee is not available, shifts that the employee would want to work, and various other constraints. In addition, the employee database 109 may include employment information, which may indicate current or past employers of the employee. For example, the employee may have multiple employers at the same time, which the system 100 may take into account when scheduling the employee.

Furthermore, in some cases, the employee information may include an employee history, such as the employee's attendance record at a past employer and performance history at a past employer. Additionally, the employee information in the employee database 111 may include other employee information such as employee contact information, employee demographic data, and employee payroll information.

Information relating to employers and employees may be created via a graphical user interface, as discussed below, and maintained by the knowledge base 103 using any suitable types of data structures, and using any suitable data storage or database techniques. In some examples, the information may be maintained in a relational database in which pieces of information for individual employee profiles and employer profiles may be stored distinctly from one another, but are related to or otherwise associated with particular profiles in the relational database. Other types of storage techniques are contemplated for generating and maintaining the information within knowledge base 103.

As shown in FIG. 1, communication component 101 and knowledge base 103 further interoperate with a schedule engine 105 which is configured to generate one or more optimized schedules based on the received request and information from knowledge base 103. More specifically, and as discussed in detail below, the schedule engine 107 may be configured to partition the demand data to create daily shift configurations, optimize the daily shift configurations, assemble the optimized daily shift configurations to produce weekly shift configurations, produce a plurality of assignment sets, calculate a fitness score, perform simulated annealing techniques, and generate an optimized schedule.

When scheduling particular employees for particular shifts, the scheduling engine 105 may consider information about the individual employees as well as information about the employer's business. For example, the scheduling engine 105 may attempt to schedule employees based on a globally equitable solution in which employees have similar hours and the most number of constraints are taken into account. Accordingly, the scheduling module 105 may evaluate the fitness of each step in an optimization process and modify the schedule to produce a more globally equitable solution.

Also, the scheduling engine 105 may attempt to schedule the employer's best employees during times when the business is expected to have the largest number of customers. Accordingly, the scheduling module 105 may rank or otherwise rate the employees according to performance based on various factors, such as how many transactions the employees typically complete per hour or other unit of time, how much the employees typically earn in gratuities per unit of time, results of customer surveys regarding particular employees, employee history, such as may be determined from prior jobs held by particular employees, and the like. Further, the ranking or other performance rating of employees may be for particular shift times. For example, the scheduling module 105 may determine that some employees perform better during morning shifts, while other employees perform better during evening shifts.

In the illustrated exemplary system 100 of FIG. 1, a reporting component 109 may be configured to capture the optimized schedule and related information, such as to produce a report. The report can include, for example, stored information pertaining to the employee and employer, warnings related to the optimized schedule, and/or errors with the optimized schedule based on one or more constraints, which may then be output to a user.

The report produced by the reporting component 109 may be output via the communication component 101 to one or more users (i.e., employers and/or employees) through use of a communication platform. The communication platform may form by integrating the system 100 with Instant Messaging (IM), text messaging (SMS), or WebRTC (Web Real-Time Communication) software. All of these platforms facilitate real-time communication, which may create a thread of content between two or more active users.

The communication platform may further facilitate the distribution of the optimized schedule and/or other relevant information. For example, an employee may access and/or review the optimized schedule, or send a request to one or more other employees to attempt to swap shifts. The communication platform may be a direct peer-to-peer communication, eliminating the need to install plugins or download native apps, and increasing security of employee information in a communication thread.

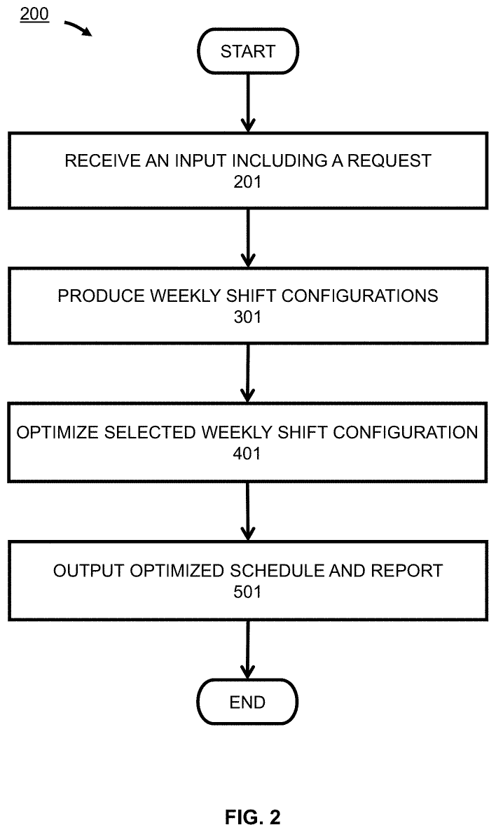

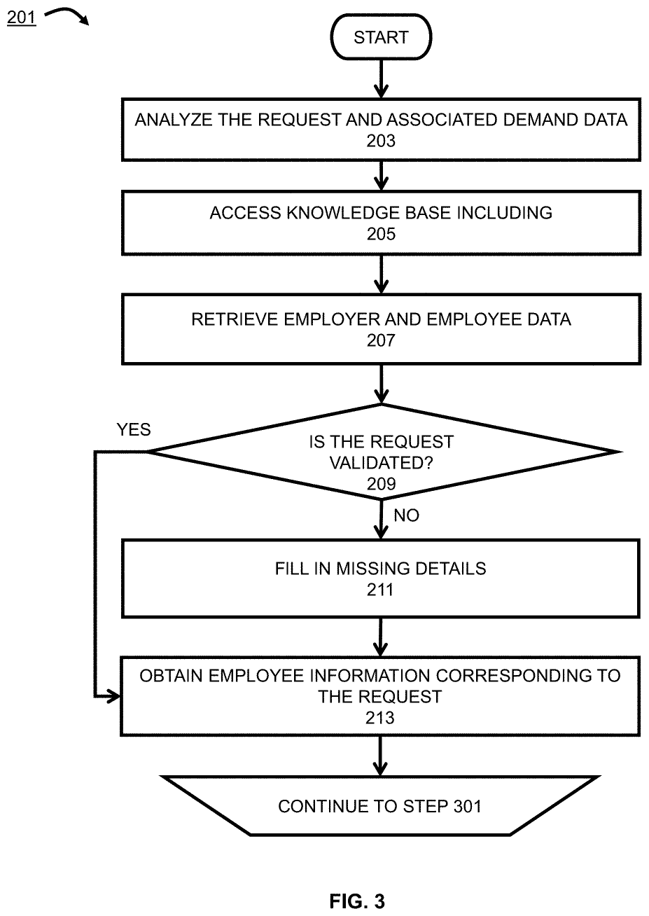

FIG. 2 is a flowchart 200 illustrating the steps of an exemplary operation of the system 100. The method of operation begins and, in step 201, an input is received including a request for an optimized schedule. In step 301, weekly shift configurations are produced based on a received request from the employer. In step 401, employees are assigned to duty periods of each daily shift configuration and the weekly shift configurations are optimized. In step 501, an optimized schedule and corresponding report are output for display to a user. FIG. 3 through FIG. 6 illustrate flowcharts further detailing the exemplary operation of system 100 illustrated in FIG. 2.

FIG. 3 is a flowchart providing more detail of step 201 of FIG. 2. The operation begins and, in step 203, the system 100 may analyze the request and associated demand data, such as a preliminary shift schedule for a plurality of shifts, for a particular duty period, or for a duration of time. The employer may be any business, enterprise, or other entity that offers, sells, supplies or otherwise enables the system 100 described herein. Once the request is received, in step 205, the system 100 may access the knowledge base 103 and, in step 207, retrieve employer and employee information relating to the request.

In decision step 209, the system 100 may determine whether the request is validated. For example, the system 100 may determine whether the request corresponds to a schedule and/or whether the demand data is in a proper format. For instance, the system 100 will make sure that the request includes general information, such as the location of the employer's business, the number of duty periods, the skill type, the employees associated with the request, and other relevant information. If at decision step 209, the system 100 determines that the request is not valid, at step 211, the system 100 will attempt to fill in missing details from the request based on information obtained from the employer database. If at decision step 209, the request is validated, in step 213, the system 100 will obtain employee information from the employee database corresponding to the request.

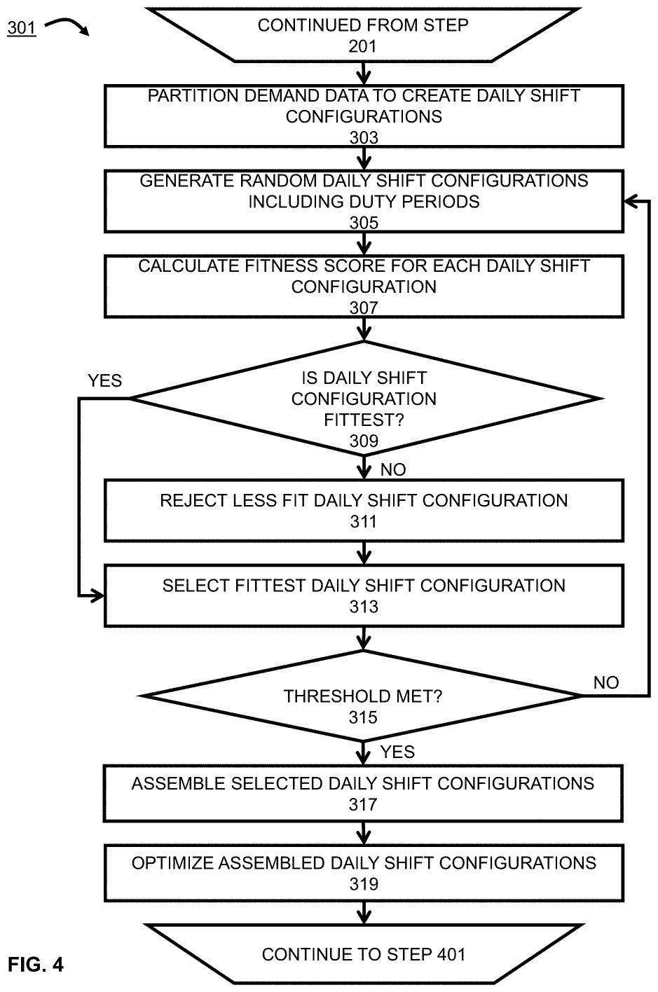

FIG. 4 is a flowchart providing more detail of step 301 of FIG. 2. The operation is continued from step 201 of FIG. 2 and, in step 303, the demand data is partitioned to create one or more daily shift configurations. For example, the demand data may be partitioned by day of the week (i.e., Monday-Friday). In step 305, the system 100 may generate random daily shift configurations including duty periods for each day of the week. In certain embodiments, for each partition, numerous (default may be set to 1000) random shift configurations are generated into a population. Most individual shifts come directly from the demand data, but each configuration is given the opportunity to develop mutations that deviate from the demand data and additional shifts are generated.

In step 307, a fitness score is calculated for each daily shift configuration. Each shift configuration is evaluated for fitness, which may be calculated as a number between 0 and 1. This number may reflect how well the daily shift configuration meet the demands of the employer while minimizing the number of minutes scheduled. A fitness score of 0 may represent that a generated daily shift configuration does not meet any of the employer's demands. A fitness score of 1 may represent that a generated daily shift configuration meets all the employer's demands. In certain embodiments, weights and biases are associated with each duty periods of a daily shift configuration impacting the calculated fitness score. For example, a single 10 hour duty period will have a lower fitness score than two 5 hour duty periods. If two or more daily shift configuration have the same fitness score, the system 100 may continue to develop mutations and increase the fitness score and/or arbitrarily select one of the daily shift configurations.

In decision step 309, the system 100 may determine whether a subsequent daily shift configuration is more fit than previous iterations. In other words, each daily shift configuration may be matched up against others based upon their calculated fitness score. The greater the fitness, the greater the chance that daily shift configuration will win the match. If at decision step 309, the subsequent shift configuration does not have a greater fitness, in step 311, the less fit daily shift configuration is rejected. If at decision step 309, the subsequent shift configuration is more fit, in step 313, the system 100 may select the fittest daily shift configuration. In certain embodiments, selected daily shift configurations may be cross-breed (e.g., switch duty periods between two or more selected daily shift configurations) in an attempt to better the fitness score.

In addition, each shift configuration may be altered. Examples of alterations may include slight modifications to the duty period, random reassignment to a different day, and/or random reassignment to a different skill type (e.g., type of labor). In certain embodiments, the system 100 may use certain information from the knowledge base 103, such as historical data and/or foot traffic data, to influence one or more alterations.

In decision step 315, the system 100 will determine whether a threshold is met. Examples of thresholds may include a number of iterations that the system 100 performs or a minimum fitness score. If at decision step 315, the threshold is not met, the process reverts back to step 305 and different random daily shift configurations are generated. If at decision step 315, the threshold is met, in step 317, the system 100 assembles the selected daily shift configurations to produce one or more weekly shift configurations.

In step 319, weekly shift configurations may be put through a simulated annealing optimizer that attempts to break up and recombine adjacent duty periods and/or weekly shift configurations in order to, for example, produce shifts within a range of optimal durations. During this process, random permutations may be applied one-at-a-time, and may be allowed to persist either if they maintain or improve upon the calculated fitness score, and improve upon the weekly shift configuration's conformity to optimal duration ranges, or if they do not and they pass a small random game-of-chance. The odds of winning the game changes as the process is iterated upon, up to 100,000 times, for example, by default. Solutions may be evaluated for fitness based upon how optimal each weekly shift configuration is determined to be based upon its start and end time. This fitness score may be calculated as a number from zero to 2\hat{ }32−1. The fittest weekly shift configuration is chosen and continues to step 401.

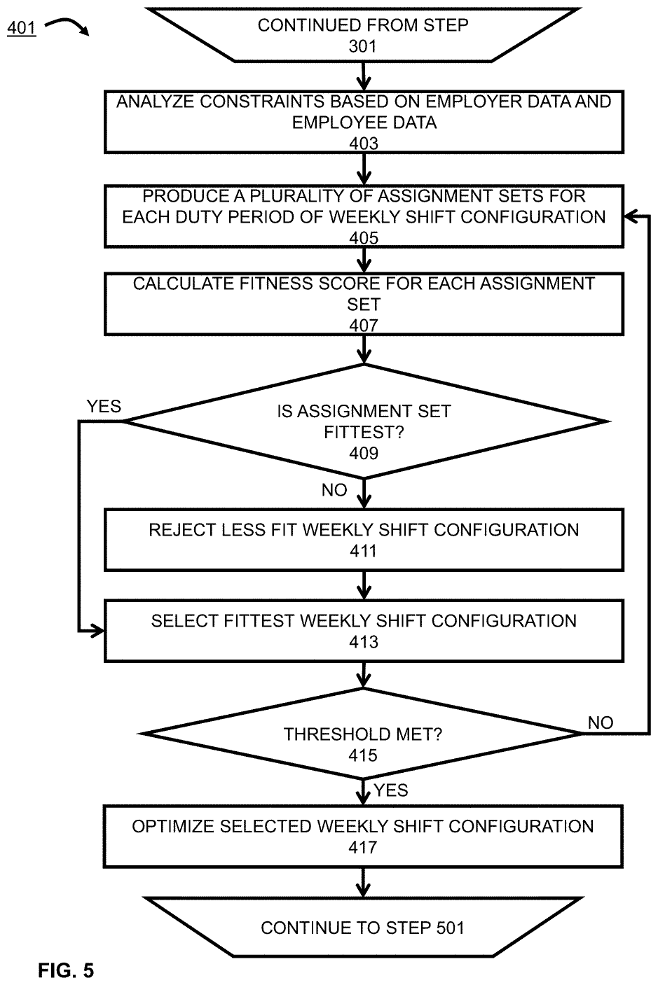

FIG. 5 is a flowchart providing more detail of step 401 of FIG. 2. The operation is continued from step 301 of FIG. 2 and, in step 403, the system 100 is configured to analyze constraints associated with the employer and employee. Examples of constraints for an employer may include local and federal labor laws, scheduling requirements, avoiding overtime pay, grouping certain employees with certain other employees, and the like. Examples of constraints for an employee may include preferences for particular duty periods and skill types, availability or unavailability for particular duty periods and/or days, requests for vacation and sick days, and the like.

In step 405, a plurality of assignment sets are produced for each duty period of the selected weekly shift configuration. In certain embodiments, the assignment set includes numerous (default may be 500) random sets of assignments for each duty period in the weekly shift configuration using a roster of employees, forming a population of potential schedules.

In step 407, a fitness score is calculated for each assignment set. Each set of assignments is evaluated for fitness, which may be calculated as a numerical value represented by a 64-bit base-2 format double-precision floating point as specified by the IEEE 754-2008 standard. In certain embodiments, positive values are fit, negative values are undesirable, and calculations resulting in an absolute value of 1 are exceptionally strong or weak, depending on their sign. The calculated fitness score may reflects how well the assignments meet the analyzed constraints. For example, the fitness score may represent how well the assignment set meets all business and logical constraints, including but not limited to number of hours worked in a week, number of days worked in a week, number of shifts left unassigned, and impossibilities such as scheduling conflicts. In addition, the fitness score may represent how well the assignment set meets the preferences of the employees, including but not limited, to preferences for working particular days, hours, positions, or at particular locations. Other factors, such as employee feedback, may further influence the fitness score.

In decision step 409, the system 100 may determine whether a subsequent assignment set is more fit than previous iterations. In other words, each assignment set may be matched up against others based upon their calculated fitness score. The greater the fitness, the greater the chance that assignment set will win the match. If at decision step 409, the subsequent assignment set does not have a greater fitness, in step 411, the less fit assignment set is rejected. If at decision step 409, the subsequent assignment is more fit, in step 413, the system 100 may select one or more weekly shift configurations associated with the fittest assignment sets. In certain embodiments, selected assignment sets may be cross-breed (e.g., switch duty periods and/or employees between two or more selected weekly shift configurations) in an attempt to better the fitness score.

In addition, each shift configuration may be altered. Examples of alterations may include swapping two assignment sets between similar duty periods, randomly reassigning a duty period, randomly creating vacant duty periods, and/or randomly assigning an employee to a vacant duty period. In certain embodiments, the system 100 may use certain information from the knowledge base, such as historical data and/or foot traffic data, to influence one or more alterations.

In decision step 415, the system 100 will determine whether a threshold is met. The threshold may be a number of iterations that the system performs or a minimum fitness score for the weekly shift configurations. If at decision step 415, the threshold is not met, the process reverts back to step 405 and different random daily shift configurations are generated.

If at decision step 415, the threshold is met, in step 417, the system 100 may optimize the selected weekly shift configuration. The selected weekly shift configuration may be put through a simulated annealing optimizer that may attempt to reassign shifts in order to produce a more globally equitable solution. Global equitability may refer to how fairly (similar happiness, similar number of hours) employees in similar work situations (where they can work, what sorts of work they can do) are treated. During this process, random permutations may be applied one-at-a-time, and may be allowed to persist if they maintain or improve the calculate fitness score and improve upon the solution's global equitability, or if they do not and they pass a small random game-of-chance. The odds of winning the game changes as the process is iterated upon, up to, for example, 100,000 times by default. Solutions may be evaluated for fitness based upon the variance in quality (number of hours, degree of happiness) across every employee assigned shifts. This fitness is calculated as a list of numbers from zero to 2\hat{ }32−1, with each number being weighted higher in the comparison based upon its position. The fittest set of assignments is chosen and passes to the step 501.

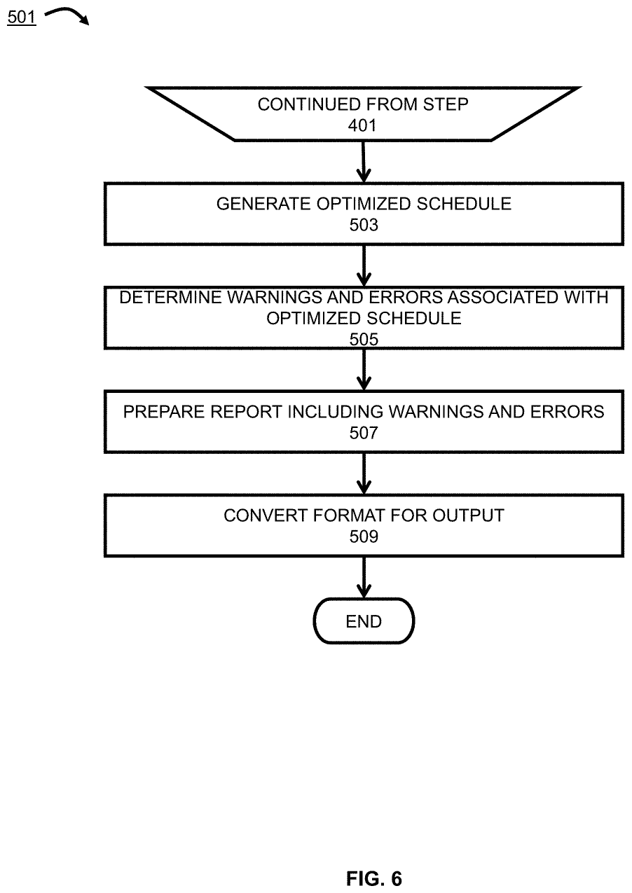

FIG. 6 is a flowchart providing more detail of step 501 of FIG. 2. The operation is continued from step 401 of FIG. 2 and, in step 503, the system 100 is configured to generate the optimized schedule based on the selected weekly shift configuration. In step 505, the system 100 may determines whether there are any warning or errors associated with the optimized schedule. A warning may represent that the schedule may make an employer or an employee unhappy. For example, one or more duty periods may be too close together, an employee may be working too much, and/or and employee hasn't taken a vacation in a long time. On the other hand, an error may represent a conflict between the optimized schedule and one or more constraints associated with an employer or employee. Examples of errors may include vacant duty periods, scheduling an unavailable employee, improper scheduling based on local or federal laws, and the like. In certain embodiments, the system 100 may not produce a schedule, for example, if there are too many errors.

In step 507, the system 100 may be configured to prepare a report including the determined warning and errors. In step 509, the format of the report may be converted for output, such as on a display. If no errors were encountered, then optimized schedule may be reported to, for example, a consuming application of a client device. In addition, the system may prepare a schedule for a specific employee and communicate that schedule, such as through the notification “your schedule is now available.” Other communication methods are further contemplated.

It is further contemplated that the system 100 is configurable to perform a number of other operations. For example, the system may provide for arbitrary, configurable, and dynamic prioritization, organization, and combination of optimization phases based upon the size and scale of the schedule being generated, employer rules, user preferences, and other factors. In another example, the system may collect and maintain data on the scheduling engine's internal performance on a per-organization basis, and use this data to provide analytics and insights about the employer, such as whether the employer is under or over-staffed. In yet another example, the system may, record which employees received the most desirable assignments (which may be quantified via a number of inputs, including individual preferences, value of the shift due to tips, number of hours, and the like), and use this data to, for example, maximize employee happiness and/or provide insights to the employer.

Exemplary Scheduling Application

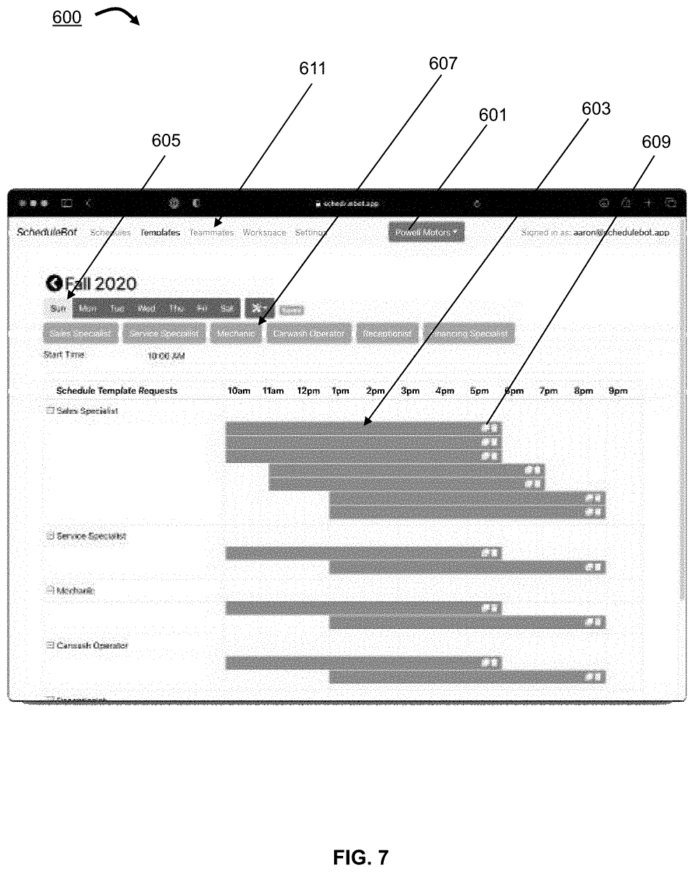

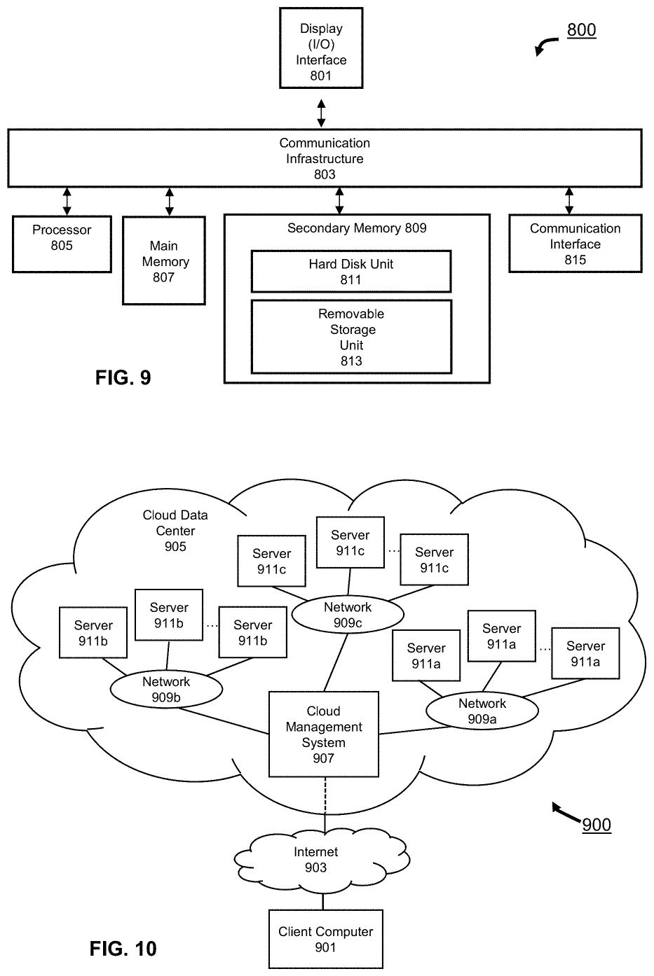

Turning to FIG. 7, an exemplary user interface of a scheduling application 600 is shown. The scheduling application 600 may be provided, for example, by a server (such as a server described in FIG. 9). The scheduling application 600 may be a stand-alone application running on a computer such as a workstation computer, laptop computer, handheld computer, tablet, mobile messaging device, or the like which may all utilize different hardware and/or software packages. Alternatively, or additionally, scheduling application 600 may connect to a server via a network, such as the Internet, using a standard browser application. A browser based implementation allows system features to be accessible regardless of the underlying platform of the scheduling application 600. Other methods may be used to implement the scheduling application 600. As should be apparent to one of ordinary skill in the art from the disclosure herein, other related services may also be provided.

As shown in FIG. 7, the user interface provides administrative functions for a specific employer 601, “Powell Motors.” The employer 601 may input demands via the interface corresponding to proposed duty periods 603 for a specific day 605, which is Sunday in the illustrated FIG. 7. Each duty period 603 corresponds to one or more skills 607, which are shown as into “Sales Specialist,” “Service Specialist,” “Mechanic,” “Carwash Operator,” “Receptionist,” and “Financing Specialist.” In certain embodiments, the scheduling application can “anchor” assignments in their requests to the scheduling engine, forcing the engine to solve specific demands in certain ways.

Other features may be triggered in response to a user selecting the one or more options 609 at the end of each duty period, which may provide different views and/or allow the user to make notes. While the illustrated user interface corresponds to a view of the “Templates” tab, additional information and views may be shown in response to a user selecting the one or more tabs 611, which are shown as “Schedules,” “Teammates,” “Workspace,” and “Settings.”

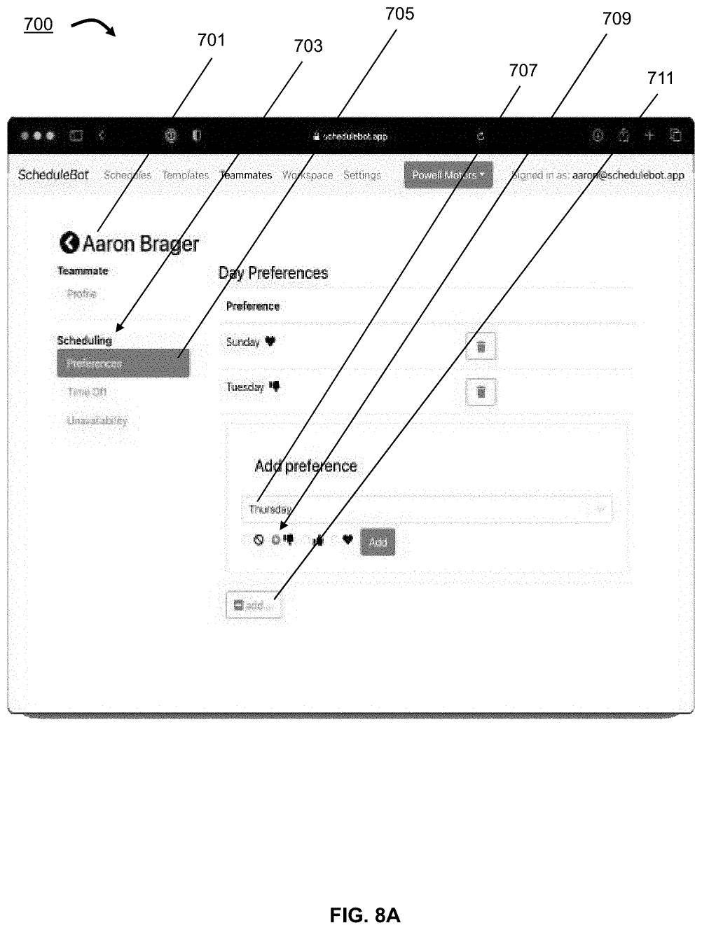

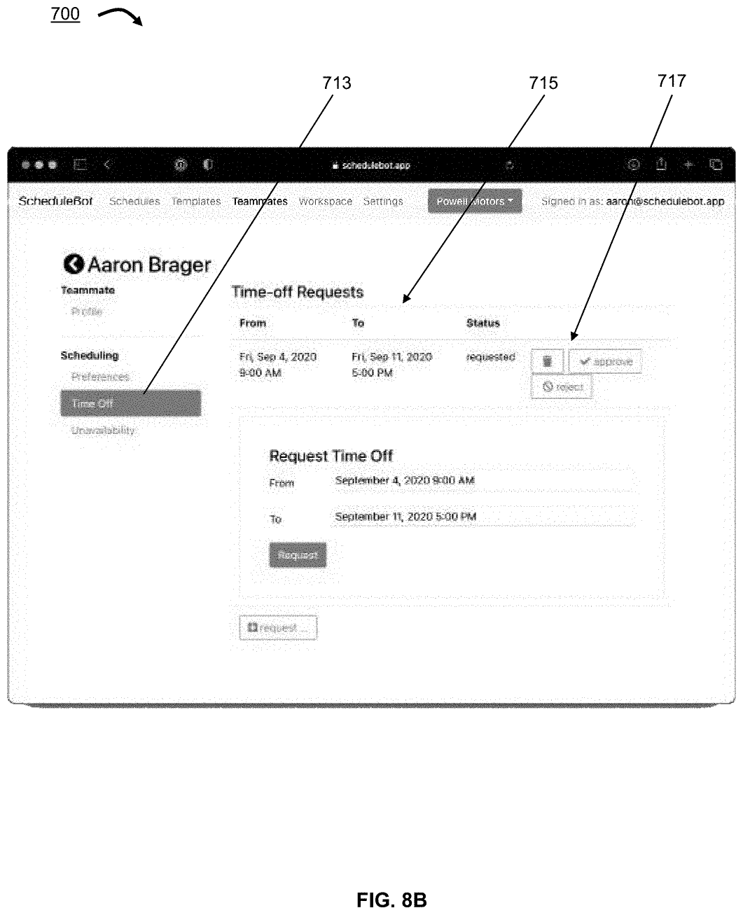

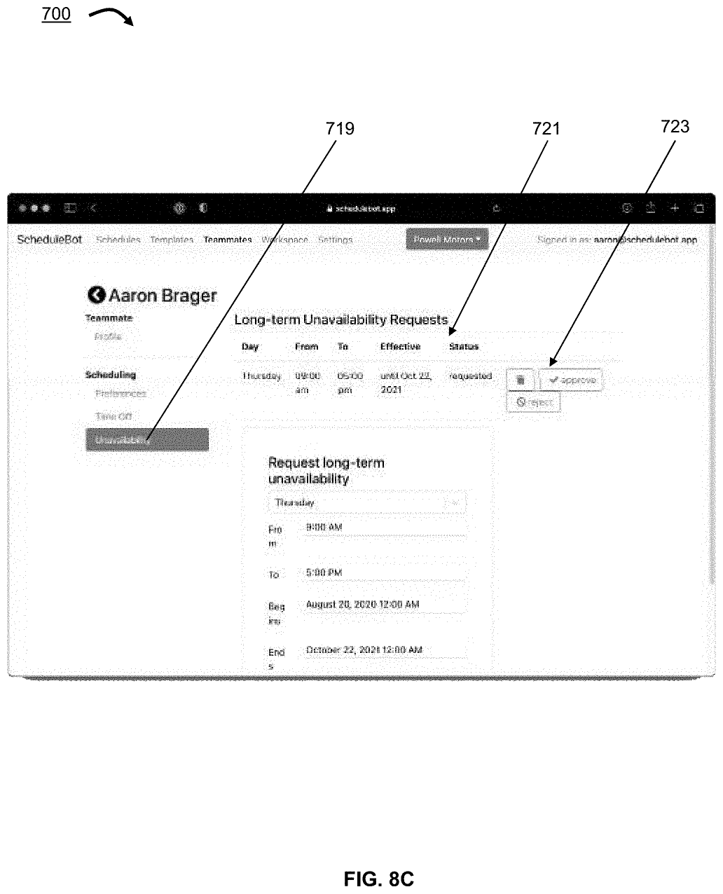

FIGS. 8A, 8B, 8C illustrate an additional exemplary user interface 700 of the scheduling application 600 corresponding to an employee 701, “Aaron Brager.” As shown, through use of user interface 700, a user, such as the employee or employer, may set certain scheduling constraints 703, which are broken down into “Preferences,” “Time Off,” and “Unavailability.” On the “Preferences” constraint 705, shown in FIG. 8A, the user may enter scheduling preferences for a particular day. For instances, the employee may specify a day 707 (“Thursday”) and associate that day with one or more preference options 709. The preference options 709 may be any type of indicia, such as text, images, media, and/or hyperlinks. Additional preferences may be added in response to the user selecting the “add” button 711.

As shown in FIG. 8B, a user may enter time-off requests through the “Time Off” constraint 713. Information relating to the time-off request may be illustrated as a table 715 including “From,” “To,” and “Status” columns. As shown, the current request in table 715 has a “requested” status. A user with administrative functions may access the time-off request and select an option 717 corresponding to the request, such as “approved” or “rejected.”

As shown in FIG. 8C, a user may enter long-term unavailability requests through the “Unavailability” constraint 719. Information relating to the long-term unavailability request may be illustrated as a table 721 including “Day,” “From,” “To,” “Effective,” and “Status” columns. As shown, the current request in table 721 has a “requested” status. A user with administrative functions may access the long-term unavailability request and select an option 723 corresponding to the request, such as “approved” or “rejected.”

Exemplary Computer System

FIG. 9 illustrates a diagram of a system of which may be an embodiment of the present invention. Computer system 800 includes an input/output interface 801 connected to communication infrastructure 803—such as a bus —, which forwards data such as graphics, text, and information, from the communication infrastructure 803 or from a frame buffer (not shown) to other components of the computer system 800. The input/output interface 801 may be, for example, a display device, a keyboard, touch screen, joystick, trackball, mouse, monitor, speaker, printer, Google Glass® unit, web camera, any other computer peripheral device, or any combination thereof, capable of entering and/or viewing data.

Computer system 800 includes one or more processors 805, which may be a special purpose or a general-purpose digital signal processor configured to process certain information. Computer system 800 also includes a main memory 807, for example random access memory (RAM), read-only memory (ROM), mass storage device, or combinations of each. Computer system 800 may also include a secondary memory 809 such as a hard disk unit 811, a removable storage unit 813, or combinations of each. Computer system 800 may also include a communication interface 815, for example, a modem, a network interface (such as an Ethernet card or Ethernet cable), a communication port, a PCMCIA slot and card, wired or wireless systems (such as Wi-Fi, Bluetooth, Infrared), local area networks, wide area networks, intranets, etc.

It is contemplated that the main memory 807, secondary memory 809, communication interface 815, or combinations of each, function as a computer usable storage medium, otherwise referred to as a computer readable storage medium, to store and/or access computer software including computer instructions. For example, computer programs or other instructions may be loaded into the computer system 800 such as through a removable storage device, for example, a floppy disk, ZIP disks, magnetic tape, portable flash drive, optical disk such as a CD or DVD or Blu-ray, Micro-Electro-Mechanical Systems (MEMS), nanotechnological apparatus. Specifically, computer software including computer instructions may be transferred from the removable storage unit 813 or hard disc unit 811 to the secondary memory 809 or through the communication infrastructure 703 to the main memory 807 of the computer system 800.

Communication interface 815 allows software, instructions and data to be transferred between the computer system 800 and external devices or external networks. Software, instructions, and/or data transferred by the communication interface 815 are typically in the form of signals that may be electronic, electromagnetic, optical or other signals capable of being sent and received by the communication interface 815. Signals may be sent and received using wire or cable, fiber optics, a phone line, a cellular phone link, a Radio Frequency (RF) link, wireless link, or other communication channels.

Computer programs, when executed, enable the computer system 800, particularly the processor 805, to implement the disclosed methods according to computer software including instructions.

The computer system 800 described may perform any one of, or any combination of, the steps of any of the methods according to the invention. It is also contemplated that the methods according to the invention may be performed automatically.

The computer system 800 of FIG. 9 is provided only for purposes of illustration, such that the invention is not limited to this specific embodiment. It is appreciated that a person skilled in the relevant art knows how to program and implement the invention using any computer system.

The computer system 800 may be a handheld device and include any small-sized computer device including, for example, a personal digital assistant (PDA), smart handheld computing device, cellular telephone, or a laptop or netbook computer, hand held console or MP3 player, tablet, or similar hand held computer device, such as an iPad®, iPad Touch® or iPhone®.

Exemplary Cloud Computing System

FIG. 10 illustrates an exemplary cloud computing system 900 that may be an embodiment of the present invention. The cloud computing system 900 includes a plurality of interconnected computing environments. The cloud computing system 900 utilizes the resources from various networks as a collective virtual computer, where the services and applications can run independently from a particular computer or server configuration making hardware less important.

Specifically, the cloud computing system 900 includes at least one client computer 901. The client computer 901 may be any device through the use of which a distributed computing environment may be accessed to perform the methods disclosed herein, for example, a traditional computer, portable computer, mobile phone, personal digital assistant, tablet to name a few. The client computer 901 includes memory such as random access memory (RAM), read-only memory (ROM), mass storage device, or any combination thereof. The memory functions as a computer usable storage medium, otherwise referred to as a computer readable storage medium, to store and/or access computer software and/or instructions.

The client computer 901 also may include a communications interface, for example, a modem, a network interface (such as an Ethernet card), a communications port, a PCMCIA slot and card, wired or wireless systems, etc. The communications interface allows communication through transferred signals between the client computer 901 and external devices including networks such as the Internet 903 and cloud data center 905. Communication may be implemented using wireless or wired capability such as cable, fiber optics, a phone line, a cellular phone link, radio waves or other communication channels.

The client computer 901 establishes communication with the Internet 903—specifically to one or more servers—to, in turn, establish communication with one or more cloud data centers 905. A cloud data center 905 includes one or more networks 909a, 909b, 909c managed through a cloud management system 907. Each network 909a, 909b, 909c includes resource servers 911a, 911b, 911c, respectively. Servers 911a, 911b, 911c permit access to a collection of computing resources and components that can be invoked to instantiate a virtual machine, process, or other resource for a limited or defined duration. For example, one group of resource servers can host and serve an operating system or components thereof to deliver and instantiate a virtual machine. Another group of resource servers can accept requests to host computing cycles or processor time, to supply a defined level of processing power for a virtual machine. A further group of resource servers can host and serve applications to load on an instantiation of a virtual machine, such as an email client, a browser application, a messaging application, or other applications or software.

The cloud management system 907 can comprise a dedicated or centralized server and/or other software, hardware, and network tools to communicate with one or more networks 909a, 909b, 909c, such as the Internet or other public or private network, with all sets of resource servers 911a, 911b, 811c. The cloud management system 907 may be configured to query and identify the computing resources and components managed by the set of resource servers 911a, 911b, 911c needed and available for use in the cloud data center 905. Specifically, the cloud management system 907 may be configured to identify the hardware resources and components such as type and amount of processing power, type and amount of memory, type and amount of storage, type and amount of network bandwidth and the like, of the set of resource servers 911a, 911b, 911c needed and available for use in the cloud data center 905. Likewise, the cloud management system 907 can be configured to identify the software resources and components, such as type of Operating System (OS), application programs, and the like, of the set of resource servers 911a, 911b, 911c needed and available for use in the cloud data center 905.

The present invention is also directed to computer products, otherwise referred to as computer program products, to provide software to the cloud computing system 900. Computer products store software on any computer useable medium, known now or in the future. Such software, when executed, may implement the methods according to certain embodiments of the invention. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, Micro-Electro-Mechanical Systems (MEMS), nanotechnological storage device, etc.), and communication mediums (e.g., wired and wireless communications networks, local area networks, wide area networks, intranets, etc.). It is to be appreciated that the embodiments described herein may be implemented using software, hardware, firmware, or combinations thereof.

The cloud computing system 900 of FIG. 10 is provided only for purposes of illustration and does not limit the invention to this specific embodiment. It is appreciated that a person skilled in the relevant art knows how to program and implement the invention using any computer system or network architecture.

### Example 1 Scheduling Process: Request and Demand

The scheduling engine receives a request to generate a schedule for a restaurant during the week of Dec. 30, 2019 through Jan. 5, 2020. It receives a message from a scheduling application in a non-human-readable format, validates it, and converts it into its own problem representation, presented below in a human readable format:

Monday: The restaurant is closed.

Tuesday: The restaurant needs 6 servers from 3:30 pm to 10:30 pm; 2 Bartenders form 3:30 pm until 11:00 pm; a host from 3 pm-4:30 pm, two hosts from 4:30 pm-8:30 pm, and a host from 8:30 pm-10:30 pm; a food runner from 4 pm-10 pm; two members of support staff from 4 pm-10:30 pm; two members of kitchen staff from 10:30 am-10:30 pm, one member of kitchen staff from 9 am-3:15 pm, and seven members of kitchen staff from 2 pm-11 pm; a manager from 2 pm-12:30 am.

Wednesday: The restaurant needs 4 servers from 11 am-5 pm; a bartender from 10 am-10:30 am, two bartenders from 10:30 am-5 pm, and a bartender from 5 pm-5:30 pm; a member of support staff from 11:00 am to 5 pm; 8 members of kitchen staff from 10 am-5 pm and a member of kitchen staff from 9 am-3:15 pm; a manager from 10:30 am-6 pm.

Thursday: The restaurant is closed.

Friday: The restaurant needs 7 servers from 3:30 pm to 10:30 pm; one bartender from 3 pm-3:30 pm, two bartenders from 3:30 pm-4 pm, three bartenders from 4 pm-9 pm, and two bartenders from 9 pm-11 pm; a host from 3 pm-4:30 pm, two hosts from 4:30 pm-8:30 pm, and a host from 8:30 pm-10:30 pm; two members of support staff from 4 pm-10:30 pm; a manager from 2 pm-12:30 am; 6 members of kitchen staff from 2 pm-11 pm, two members of kitchen staff from 10:30 am-10:30 pm, and a member of kitchen staff from 9 am-3:15 pm.

Saturday: The restaurant needs 8 servers from 3:30 pm to 10:30 pm; seven members of kitchen staff from 2 pm-11 pm and two members of kitchen staff from 10:30 am-10:30 pm; a manager from 2 pm-12:30 am; two members of support staff from 4 pm-10:30 pm; a host from 3 pm-8:30 pm and a host from 4:30 pm to 10:30 pm; a bartender from 3 pm-11 pm and a bartender from 4 pm-11 pm.

Sunday: The restaurant needs 4 servers from 3:30 pm to 10:30 pm; A bartender from 3:30 pm-11 pm; a host from 3:30 pm-9:30 pm; a member of support staff from 4 pm-10:30 pm; a food runner from 4 pm-10 pm; a manager from 2 pm-12:30 am; five members of kitchen staff from 2 pm-11 pm.

Servers—There are 10 servers on staff, named Alpha Billy, Beta David, Gamma One, Delta Delta, Orange Bread, Banana Juice, Apple Candy, Watermelon Sauce, Happy Pasta, and Sad Potato. Alpha Billy does not want to work on Tuesday, Beta David and Watermelon Sauce does not want to work Tuesday or Wednesday, Delta Delta does not want to work Tuesday through Thursday or Sunday, Orange Bread does not want to work Wednesday, Apple Candy does not want to work Sunday, Happy Pasta does not want to work Monday, and Sad Potato does not want to work Monday through Friday.

Bartenders—There are 2 bartenders on staff named Soda Pop and Fizzy Drink.

Hosts—There are 4 hosts on staff named Welcome Welcome, This Way, Sit Here, and Right With You. Welcome Welcome does not want to work Tuesday through Friday and Sit Here does not want to work Friday.

Support—There are 5 employees working support and food runner positions on staff, named Strut Holder, Pillar Concrete, Hinge Joint, Glue Staple, and Rope Rigging. Strut Holder only wants to work Thursday, Pillar Concrete only wants to work Thursday through Saturday, and Glue Staple only wants to work Wednesdays and Weekends.

Managers—There are 2 shift managers, named Pointy Hair and Golf Cocktail. Golf Cocktail can also work as a bartender.

Kitchen Staff—There are 11 members of kitchen staff, named Booth Train, Plates Coy, Fork Spoon, Knife Haver, Tray Slip, Napkin Cloth, Apps Snacks, Entree Meal, Cake Pie, Salad Greens, and Sherbert Herbert.

### Example 2 Scheduling Process: Generating Shift Configurations

In the next step, the scheduling engine generates and optimizes thousands of sets of unassigned shifts to be fulfilled based upon the input, arriving at a final set of shifts to assign employees to. This is presented below in a human readable format:

| --------------------------- | |
|---|---|
| --------------------------- | |
| MONDAY | |
| No shifts generated. | |
| --------------------------- | |
| --------------------------- | |
| TUESDAY | |
| [Bar] | 15:30 to 23:00 |
| [Bar] | 15:30 to 23:00 |
| [Food Runner] | 16:00 to 22:00 |
| [Host] | 15:00 to 20:30 |
| [Host] | 16:30 to 22:15 |
| [Kitchen] | 09:00 to 15:15 |
| [Kitchen] | 10:30 to 16:30 |
| [Kitchen] | 10:30 to 16:30 |
| [Kitchen] | 14:00 to 23:00 |
| [Kitchen] | 14:00 to 23:00 |
| [Kitchen] | 14:00 to 23:00 |
| [Kitchen] | 14:00 to 23:00 |
| [Kitchen] | 14:00 to 23:00 |
| [Kitchen] | 14:00 to 23:00 |
| [Kitchen] | 14:00 to 23:00 |
| [Kitchen] | 16:30 to 22:30 |
| [Kitchen] | 16:30 to 22:45 |
| [Manager] | 14:00 to 00:30 |
| [Server] | 15:30 to 22:30 |
| [Server] | 15:30 to 22:30 |
| [Server] | 15:30 to 22:30 |
| [Server] | 15:30 to 22:30 |
| [Server] | 15:30 to 22:30 |
| [Server] | 15:30 to 22:30 |
| [Support] | 16:00 to 22:30 |
| [Support] | 16:00 to 22:30 |
| --------------------------- | |
| --------------------------- | |
| WEDNESDAY | |
| [Bar] | 10:00 to 17:30 |
| [Bar] | 10:30 to 17:00 |
| [Host] | 11:00 to 17:00 |
| [Kitchen] | 09:00 to 15:15 |
| [Kitchen] | 10:00 to 17:00 |
| [Kitchen] | 10:00 to 17:00 |
| [Kitchen] | 10:00 to 17:00 |
| [Kitchen] | 10:00 to 17:00 |
| [Kitchen] | 10:00 to 17:00 |
| [Kitchen] | 10:00 to 17:00 |
| [Kitchen] | 10:00 to 17:00 |
| [Kitchen] | 10:00 to 17:00 |
| [Manager] | 10:30 to 18:00 |
| [Server] | 11:00 to 17:00 |
| [Server] | 11:00 to 17:00 |
| [Server] | 11:00 to 17:00 |
| [Server] | 11:00 to 17:00 |
| [Support] | 11:00 to 17:00 |
| --------------------------- | |
| --------------------------- | |
| THURSDAY | |
| No shifts generated. | |
| --------------------------- | |
| --------------------------- | |
| FRIDAY | |
| [Bar] | 15:00 to 23:00 |
| [Bar] | 15:30 to 23:00 |
| [Bar] | 15:45 to 21:00 |
| [Host] | 15:00 to 20:30 |
| [Host] | 16:30 to 22:30 |
| [Kitchen] | 09:00 to 15:15 |
| [Kitchen] | 10:30 to 16:30 |
| [Kitchen] | 10:30 to 16:30 |
| [Kitchen] | 14:00 to 23:00 |
| [Kitchen] | 14:00 to 23:00 |
| [Kitchen] | 14:00 to 23:00 |
| [Kitchen] | 14:00 to 23:00 |
| [Kitchen] | 14:00 to 23:00 |
| [Kitchen] | 14:00 to 23:00 |
| [Kitchen] | 16:30 to 22:30 |
| [Kitchen] | 16:30 to 22:30 |
| [Manager] | 14:00 to 00:30 |
| [Server] | 15:30 to 22:30 |
| [Server] | 15:30 to 22:30 |
| [Server] | 15:30 to 22:30 |
| [Server] | 15:30 to 22:30 |
| [Server] | 15:30 to 22:30 |
| [Server] | 15:30 to 22:30 |
| [Server] | 15:30 to 22:30 |
| [Support] | 16:00 to 22:15 |
| [Support] | 16:00 to 22:30 |
| --------------------------- | |
| --------------------------- | |
| SATURDAY | |
| [Bar] | 15:15 to 23:00 |
| [Bar] | 16:00 to 23:00 |
| [Host] | 15:00 to 20:30 |
| [Host] | 16:30 to 22:30 |
| [Kitchen] | 10:30 to 16:30 |
| [Kitchen] | 10:30 to 16:30 |
| [Kitchen] | 14:00 to 23:00 |
| [Kitchen] | 14:00 to 23:00 |
| [Kitchen] | 14:00 to 23:00 |
| [Kitchen] | 14:00 to 23:00 |
| [Kitchen] | 14:00 to 23:00 |
| [Kitchen] | 14:00 to 23:00 |
| [Kitchen] | 14:00 to 23:00 |
| [Kitchen] | 16:30 to 22:30 |
| [Kitchen] | 16:30 to 22:30 |
| [Manager] | 13:45 to 00:30 |
| [Server] | 15:30 to 22:30 |
| [Server] | 15:30 to 22:30 |
| [Server] | 15:30 to 22:30 |
| [Server] | 15:30 to 22:30 |
| [Server] | 15:30 to 22:30 |
| [Server] | 15:30 to 22:30 |
| [Server] | 15:30 to 22:30 |
| [Server] | 15:30 to 22:30 |
| [Support] | 16:00 to 22:30 |
| [Support] | 16:00 to 22:30 |
| --------------------------- | |
| --------------------------- | |
| SUNDAY | |
| [Bar] | 15:30 to 23:00 |

| | |
|---|---|
| [Food Runner] | 16:00 to 22:00 |

| | |
|---|---|
| [Host] | 15:30 to 21:30 |
| [Kitchen] | 14:00 to 23:00 |
| [Kitchen] | 14:00 to 23:00 |
| [Kitchen] | 14:00 to 23:00 |
| [Kitchen] | 14:00 to 23:00 |
| [Kitchen] | 14:00 to 23:00 |
| [Manager] | 14:00 to 00:30 |
| [Server] | 15:30 to 22:30 |
| [Server] | 15:30 to 22:30 |
| [Server] | 15:30 to 22:30 |
| [Server] | 15:30 to 22:30 |
| [Support] | 16:00 to 22:30 |

### Example 3 Scheduling Process: Producing Assignment Sets

In the next step, employees are assigned to the shifts to create a preliminary sets of assignments and then are iteratively optimized. The fittest set of assignments are passed to the next step, presented here in a human-readable format:

---------------------------
---------------------------
MONDAY
No shifts scheduled.
---------------------------
---------------------------
TUESDAY

| | | |
|---|---|---|
| [Bar] | 15:30 to 23:00 | Fizzy Drink |
| [Bar] | 15:30 to 23:00 | Golf Cocktail |
| [Food Runner] | 16:00 to 22:00 | Pillar Concrete (Prefers not to work this |

shift)

| | | |
|---|---|---|
| [Host] | 15:00 to 20:30 | This Way |
| [Host] | 16:30 to 22:15 | Sit Here |
| [Kitchen] | 09:00 to 15:15 | Sheryl Segal |
| [Kitchen] | 10:30 to 16:30 | Salad Greens |
| [Kitchen] | 10:30 to 16:30 | Sherbert Herbert |
| [Kitchen] | 14:00 to 23:00 | Apps Snacks |
| [Kitchen] | 14:00 to 23:00 | Booth Train |
| [Kitchen] | 14:00 to 23:00 | Entree Meal |
| [Kitchen] | 14:00 to 23:00 | Fork Spoon |
| [Kitchen] | 14:00 to 23:00 | Knife Haver |
| [Kitchen] | 14:00 to 23:00 | Napkin Cloth |
| [Kitchen] | 14:00 to 23:00 | Tray Slip |
| [Kitchen] | 16:30 to 22:30 | Plates Coy |
| [Kitchen] | 16:30 to 22:45 | Cake Pie |
| [Manager] | 14:00 to 00:30 | Pointy Hair |
| [Server] | 15:30 to 22:30 | Apple Candy |
| [Server] | 15:30 to 22:30 | Banana Juice |
| [Server] | 15:30 to 22:30 | Gamma One |
| [Server] | 15:30 to 22:30 | Happy Pasta |
| [Server] | 15:30 to 22:30 | Orange Bread |
| [Server] | 15:30 to 22:30 | Sad Potato (Prefers not to work this |
| | | shift) |
| [Support] | 16:00 to 22:30 | Hinge Joint |
| [Support] | 16:00 to 22:30 | Rope Rigging |

---------------------------
---------------------------
WEDNESDAY

| | | |
|---|---|---|
| [Bar] | 10:00 to 17:30 | Soda Pop |
| [Bar] | 10:30 to 17:00 | Fizzy Drink |
| [Host] | 11:00 to 17:00 | Right With You |
| [Kitchen] | 09:00 to 15:15 | Sheryl Segal |
| [Kitchen] | 10:00 to 17:00 | Apps Snacks |
| [Kitchen] | 10:00 to 17:00 | Booth Train |
| [Kitchen] | 10:00 to 17:00 | Entree Meal |
| [Kitchen] | 10:00 to 17:00 | Fork Spoon |
| [Kitchen] | 10:00 to 17:00 | Knife Haver |
| [Kitchen] | 10:00 to 17:00 | Salad Greens |
| [Kitchen] | 10:00 to 17:00 | Sherbert Herbert |
| [Kitchen] | 10:00 to 17:00 | Tray Slip |
| [Manager] | 10:30 to 18:00 | Pointy Hair |
| [Server] | 11:00 to 17:00 | Apple Candy |
| [Server] | 11:00 to 17:00 | Banana Juice |
| [Server] | 11:00 to 17:00 | Gamma One |
| [Server] | 11:00 to 17:00 | Happy Pasta |
| [Support] | 11:00 to 17:00 | Rope Rigging |

---------------------------
---------------------------
THURSDAY
No shifts scheduled.
---------------------------
---------------------------
FRIDAY

| | | |
|---|---|---|
| [Bar] | 15:00 to 23:00 | Golf Cocktail |
| [Bar] | 15:30 to 23:00 | Soda Pop |
| [Bar] | 15:45 to 21:00 | Fizzy Drink |
| [Host] | 15:00 to 20:30 | Right With You |
| [Host] | 16:30 to 22:30 | This Way |
| [Kitchen] | 09:00 to 15:15 | Sheryl Segal |
| [Kitchen] | 10:30 to 16:30 | Napkin Cloth |
| [Kitchen] | 10:30 to 16:30 | Plates Coy |
| [Kitchen] | 14:00 to 23:00 | Booth Train |
| [Kitchen] | 14:00 to 23:00 | Cake Pie |
| [Kitchen] | 14:00 to 23:00 | Fork Spoon |
| [Kitchen] | 14:00 to 23:00 | Salad Greens |
| [Kitchen] | 14:00 to 23:00 | Sherbert Herbert |
| [Kitchen] | 14:00 to 23:00 | Tray Slip |
| [Kitchen] | 16:30 to 22:30 | Entree Meal |
| [Kitchen] | 16:30 to 22:30 | Knife Haver |
| [Manager] | 14:00 to 00:30 | Golf Cocktail |
| [Server] | 15:30 to 22:30 | Alpha Billy |
| [Server] | 15:30 to 22:30 | Apple Candy |
| [Server] | 15:30 to 22:30 | Beta David |
| [Server] | 15:30 to 22:30 | Delta Delta |
| [Server] | 15:30 to 22:30 | Happy Pasta |
| [Server] | 15:30 to 22:30 | Orange Bread |
| [Server] | 15:30 to 22:30 | Watermelon Sauce |
| [Support] | 16:00 to 22:15 | Pillar Concrete |
| [Support] | 16:00 to 22:30 | Hinge Joint |

---------------------------
---------------------------
SATURDAY

| | | |
|---|---|---|
| [Bar] | 15:15 to 23:00 | Golf Cocktail |
| [Bar] | 16:00 to 23:00 | Soda Pop |
| [Host] | 15:00 to 20:30 | Sit Here |
| [Host] | 16:30 to 22:30 | Right With You |
| [Kitchen] | 10:30 to 16:30 | Apps Snacks |
| [Kitchen] | 10:30 to 16:30 | Napkin Cloth |
| [Kitchen] | 14:00 to 23:00 | Booth Train |
| [Kitchen] | 14:00 to 23:00 | Cake Pie |
| [Kitchen] | 14:00 to 23:00 | Fork Spoon |
| [Kitchen] | 14:00 to 23:00 | Plates Coy |
| [Kitchen] | 14:00 to 23:00 | Salad Greens |
| [Kitchen] | 14:00 to 23:00 | Sherbert Herbert |
| [Kitchen] | 14:00 to 23:00 | Tray Slip |
| [Kitchen] | 16:30 to 22:30 | Entree Meal |
| [Kitchen] | 16:30 to 22:30 | Knife Haver |
| [Manager] | 13:45 to 00:30 | Pointy Hair |
| [Server] | 15:30 to 22:30 | Alpha Billy |
| [Server] | 15:30 to 22:30 | Apple Candy |
| [Server] | 15:30 to 22:30 | Banana Juice |
| [Server] | 15:30 to 22:30 | Beta David |
| [Server] | 15:30 to 22:30 | Delta Delta |
| [Server] | 15:30 to 22:30 | Gamma One |
| [Server] | 15:30 to 22:30 | Orange Bread |
| [Server] | 15:30 to 22:30 | Sad Potato |
| [Support] | 16:00 to 22:30 | Glue Staple |
| [Support] | 16:00 to 22:30 | Rope Rigging |

---------------------------
---------------------------
SUNDAY

| | | |
|---|---|---|
| [Bar] | 15:30 to 23:00 | Fizzy Drink |
| [Food Runner] | 16:00 to 22:00 | Glue Staple |
| [Host] | 15:30 to 21:30 | This Way |
| [Kitchen] | 14:00 to 23:00 | Apps Snacks |
| [Kitchen] | 14:00 to 23:00 | Cake Pie |
| [Kitchen] | 14:00 to 23:00 | Napkin Cloth |
| [Kitchen] | 14:00 to 23:00 | Plates Coy |
| [Kitchen] | 14:00 to 23:00 | Salad Greens |
| [Manager] | 14:00 to 00:30 | Golf Cocktail |
| [Server] | 15:30 to 22:30 | Alpha Billy |
| [Server] | 15:30 to 22:30 | Happy Pasta |
| [Server] | 15:30 to 22:30 | Sad Potato |
| [Server] | 15:30 to 22:30 | Watermelon Sauce |
| [Support] | 16:00 to 22:30 | Rope Rigging |

---------------------------

### Example 4 Scheduling Process: Optimizating Shift Configurations

Assignments are swapped and altered to create a more equitable schedule—for example, all bartenders have similar hours, all kitchen staff have similar hours, etc. The fittest set of assignments, presented here in a human-readable format, is passed to the result compilation and output steps:

---------------------------
MONDAY
No shifts scheduled.
---------------------------
---------------------------
TUESDAY

| | | |
|---|---|---|
| [Bar] | 15:30 to 23:00 | Golf Cocktail |
| [Bar] | 15:30 to 23:00 | Soda Pop |
| [Food Runner] | 16:00 to 22:00 | Glue Staple (Prefers not to work this |
| | | shift) |
| [Host] | 15:00 to 20:30 | Right With You |
| [Host] | 16:30 to 22:15 | Sit Here |
| [Kitchen] | 09:00 to 15:15 | Sheryl Segal |
| [Kitchen] | 10:30 to 16:30 | Napkin Cloth |
| [Kitchen] | 10:30 to 16:30 | Plates Coy |
| [Kitchen] | 14:00 to 23:00 | Booth Train |
| [Kitchen] | 14:00 to 23:00 | Cake Pie |
| [Kitchen] | 14:00 to 23:00 | Entree Meal |
| [Kitchen] | 14:00 to 23:00 | Fork Spoon |
| [Kitchen] | 14:00 to 23:00 | Knife Haver |
| [Kitchen] | 14:00 to 23:00 | Salad Greens |
| [Kitchen] | 14:00 to 23:00 | Sherbert Herbert |
| [Kitchen] | 16:30 to 22:30 | Apps Snacks |
| [Kitchen] | 16:30 to 22:45 | Tray Slip |
| [Manager] | 14:00 to 00:30 | Pointy Hair |
| [Server] | 15:30 to 22:30 | Apple Candy |
| [Server] | 15:30 to 22:30 | Banana Juice |
| [Server] | 15:30 to 22:30 | Gamma One |
| [Server] | 15:30 to 22:30 | Happy Pasta |
| [Server] | 15:30 to 22:30 | Orange Bread |
| [Server] | 15:30 to 22:30 | Sad Potato (Prefers not to work this |
| | | shift) |
| [Support] | 16:00 to 22:30 | Hinge Joint |
| [Support] | 16:00 to 22:30 | Rope Rigging |

---------------------------
---------------------------
WEDNESDAY

| | | |
|---|---|---|
| [Bar] | 10:00 to 17:30 | Fizzy Drink |
| [Bar] | 10:30 to 17:00 | Soda Pop |
| [Host] | 11:00 to 17:00 | Right With You |
| [Kitchen] | 09:00 to 15:15 | Sheryl Segal |
| [Kitchen] | 10:00 to 17:00 | Apps Snacks |
| [Kitchen] | 10:00 to 17:00 | Cake Pie |
| [Kitchen] | 10:00 to 17:00 | Entree Meal |
| [Kitchen] | 10:00 to 17:00 | Fork Spoon |
| [Kitchen] | 10:00 to 17:00 | Knife Haver |
| [Kitchen] | 10:00 to 17:00 | Napkin Cloth |
| [Kitchen] | 10:00 to 17:00 | Plates Coy |
| [Kitchen] | 10:00 to 17:00 | Salad Greens |
| [Manager] | 10:30 to 18:00 | Golf Cocktail |
| [Server] | 11:00 to 17:00 | Apple Candy |
| [Server] | 11:00 to 17:00 | Banana Juice |
| [Server] | 11:00 to 17:00 | Gamma One |
| [Server] | 11:00 to 17:00 | Happy Pasta |
| [Support] | 11:00 to 17:00 | Hinge Joint |

---------------------------
---------------------------
THURSDAY
No shifts scheduled.
---------------------------
---------------------------
FRIDAY

| | | |
|---|---|---|
| [Bar] | 15:00 to 23:00 | Golf Cocktail |
| [Bar] | 15:30 to 23:00 | Soda Pop |
| [Bar] | 15:45 to 21:00 | Fizzy Drink |
| [Host] | 15:00 to 20:30 | Right With You |
| [Host] | 16:30 to 22:30 | This Way |
| [Kitchen] | 09:00 to 15:15 | Sheryl Segal |
| [Kitchen] | 10:30 to 16:30 | Booth Train |
| [Kitchen] | 10:30 to 16:30 | Cake Pie |
| [Kitchen] | 14:00 to 23:00 | Apps Snacks |
| [Kitchen] | 14:00 to 23:00 | Fork Spoon |
| [Kitchen] | 14:00 to 23:00 | Knife Haver |
| [Kitchen] | 14:00 to 23:00 | Napkin Cloth |
| [Kitchen] | 14:00 to 23:00 | Plates Coy |
| [Kitchen] | 14:00 to 23:00 | Salad Greens |
| [Kitchen] | 16:30 to 22:30 | Sherbert Herbert |
| [Kitchen] | 16:30 to 22:30 | Tray Slip |
| [Manager] | 14:00 to 00:30 | Pointy Hair |
| [Server] | 15:30 to 22:30 | Alpha Billy |
| [Server] | 15:30 to 22:30 | Banana Juice |
| [Server] | 15:30 to 22:30 | Beta David |
| [Server] | 15:30 to 22:30 | Delta Delta |
| [Server] | 15:30 to 22:30 | Happy Pasta |
| [Server] | 15:30 to 22:30 | Orange Bread |
| [Server] | 15:30 to 22:30 | Watermelon Sauce |
| [Support] | 16:00 to 22:15 | Pillar Concrete |
| [Support] | 16:00 to 22:30 | Hinge Joint |

---------------------------
---------------------------
SATURDAY

| | | |
|---|---|---|
| [Bar] | 15:15 to 23:00 | Fizzy Drink |
| [Bar] | 16:00 to 23:00 | Soda Pop |
| [Host] | 15:00 to 20:30 | Sit Here |
| [Host] | 16:30 to 22:30 | This Way |
| [Kitchen] | 10:30 to 16:30 | Apps Snacks |
| [Kitchen] | 10:30 to 16:30 | Napkin Cloth |
| [Kitchen] | 14:00 to 23:00 | Booth Train |
| [Kitchen] | 14:00 to 23:00 | Cake Pie |
| [Kitchen] | 14:00 to 23:00 | Fork Spoon |
| [Kitchen] | 14:00 to 23:00 | Plates Coy |
| [Kitchen] | 14:00 to 23:00 | Salad Greens |
| [Kitchen] | 14:00 to 23:00 | Sherbert Herbert |
| [Kitchen] | 14:00 to 23:00 | Tray Slip |
| [Kitchen] | 16:30 to 22:30 | Entree Meal |
| [Kitchen] | 16:30 to 22:30 | Knife Haver |
| [Manager] | 13:45 to 00:30 | Golf Cocktail |
| [Server] | 15:30 to 22:30 | Alpha Billy |
| [Server] | 15:30 to 22:30 | Apple Candy |
| [Server] | 15:30 to 22:30 | Beta David |
| [Server] | 15:30 to 22:30 | Delta Delta |
| [Server] | 15:30 to 22:30 | Gamma One |
| [Server] | 15:30 to 22:30 | Orange Bread |
| [Server] | 15:30 to 22:30 | Sad Potato |
| [Server] | 15:30 to 22:30 | Watermelon Sauce |
| [Support] | 16:00 to 22:30 | Pillar Concrete |
| [Support] | 16:00 to 22:30 | Rope Rigging |

---------------------------
---------------------------
SUNDAY

| | | |
|---|---|---|
| [Bar] | 15:30 to 23:00 | Fizzy Drink |
| [Food Runner] | 16:00 to 22:00 | Rope Rigging |
| [Host] | 15:30 to 21:30 | Sit Here |
| [Kitchen] | 14:00 to 23:00 | Booth Train |
| [Kitchen] | 14:00 to 23:00 | Entree Meal |
| [Kitchen] | 14:00 to 23:00 | Napkin Cloth |
| [Kitchen] | 14:00 to 23:00 | Sherbert Herbert |
| [Kitchen] | 14:00 to 23:00 | Tray Slip |
| [Manager] | 14:00 to 00:30 | Pointy Hair |
| [Server] | 15:30 to 22:30 | Alpha Billy |
| [Server] | 15:30 to 22:30 | Beta David |
| [Server] | 15:30 to 22:30 | Sad Potato |
| [Server] | 15:30 to 22:30 | Watermelon Sauce |
| [Support] | 16:00 to 22:30 | Glue Staple |

---------------------------

In the next step, the scheduling engine may perform a simulated annealing technique to produce the following results in a human readable format:

---------------------------
---------------------------
MONDAY
No shifts scheduled.
---------------------------
---------------------------
TUESDAY

| | | |
|---|---|---|
| [Bar] | 15:30 to 23:00 | Golf Cocktail |
| [Bar] | 15:30 to 23:00 | Soda Pop |
| [Food Runner] | 16:00 to 22:00 | Glue Staple (Prefers not to work |
| | | this shift) |
| [Host] | 15:00 to 20:30 | Right With You |
| [Host] | 16:30 to 22:15 | Sit Here |
| [Kitchen] | 09:00 to 15:15 | Sheryl Segal |
| [Kitchen] | 10:30 to 16:30 | Napkin Cloth |
| [Kitchen] | 10:30 to 16:30 | Plates Coy |
| [Kitchen] | 14:00 to 23:00 | Booth Train |
| [Kitchen] | 14:00 to 23:00 | Cake Pie |
| [Kitchen] | 14:00 to 23:00 | Entree Meal |
| [Kitchen] | 14:00 to 23:00 | Fork Spoon |
| [Kitchen] | 14:00 to 23:00 | Knife Haver |
| [Kitchen] | 14:00 to 23:00 | Salad Greens |
| [Kitchen] | 14:00 to 23:00 | Sherbert Herbert |
| [Kitchen] | 16:30 to 22:30 | Apps Snacks |
| [Kitchen] | 16:30 to 22:45 | Tray Slip |
| [Manager] | 14:00 to 00:30 | Pointy Hair |
| [Server] | 15:30 to 22:30 | Apple Candy |
| [Server] | 15:30 to 22:30 | Banana Juice |
| [Server] | 15:30 to 22:30 | Gamma One |
| [Server] | 15:30 to 22:30 | Happy Pasta |
| [Server] | 15:30 to 22:30 | Orange Bread |
| [Server] | 15:30 to 22:30 | Sad Potato (Prefers not to work |
| | | this shift) |
| [Support] | 16:00 to 22:30 | Hinge Joint |
| [Support] | 16:00 to 22:30 | Rope Rigging |

---------------------------
---------------------------
WEDNESDAY

| | | |
|---|---|---|
| [Bar] | 10:00 to 17:30 | Fizzy Drink |
| [Bar] | 10:30 to 17:00 | Soda Pop |
| [Host] | 11:00 to 17:00 | Right With You |
| [Kitchen] | 09:00 to 15:15 | Sheryl Segal |
| [Kitchen] | 10:00 to 17:00 | Apps Snacks |
| [Kitchen] | 10:00 to 17:00 | Cake Pie |
| [Kitchen] | 10:00 to 17:00 | Entree Meal |
| [Kitchen] | 10:00 to 17:00 | Fork Spoon |
| [Kitchen] | 10:00 to 17:00 | Knife Haver |
| [Kitchen] | 10:00 to 17:00 | Napkin Cloth |
| [Kitchen] | 10:00 to 17:00 | Plates Coy |
| [Kitchen] | 10:00 to 17:00 | Salad Greens |
| [Manager] | 10:30 to 18:00 | Golf Cocktail |
| [Server] | 11:00 to 17:00 | Apple Candy |
| [Server] | 11:00 to 17:00 | Banana Juice |
| [Server] | 11:00 to 17:00 | Gamma One |
| [Server] | 11:00 to 17:00 | Happy Pasta |
| [Support] | 11:00 to 17:00 | Hinge Joint |

---------------------------
---------------------------
THURSDAY
No shifts scheduled.
---------------------------
---------------------------
FRIDAY

| | | |
|---|---|---|
| [Bar] | 15:00 to 23:00 | Golf Cocktail |
| [Bar] | 15:30 to 23:00 | Soda Pop |
| [Bar] | 15:45 to 21:00 | Fizzy Drink |
| [Host] | 15:00 to 20:30 | Right With You |
| [Host] | 16:30 to 22:30 | This Way |
| [Kitchen] | 09:00 to 15:15 | Sheryl Segal |
| [Kitchen] | 10:30 to 16:30 | Booth Train |
| [Kitchen] | 10:30 to 16:30 | Cake Pie |
| [Kitchen] | 14:00 to 23:00 | Apps Snacks |
| [Kitchen] | 14:00 to 23:00 | Fork Spoon |
| [Kitchen] | 14:00 to 23:00 | Knife Haver |
| [Kitchen] | 14:00 to 23:00 | Napkin Cloth |
| [Kitchen] | 14:00 to 23:00 | Plates Coy |
| [Kitchen] | 14:00 to 23:00 | Salad Greens |
| [Kitchen] | 16:30 to 22:30 | Sherbert Herbert |
| [Kitchen] | 16:30 to 22:30 | Tray Slip |
| [Manager] | 14:00 to 00:30 | Pointy Hair |
| [Server] | 15:30 to 22:30 | Alpha Billy |
| [Server] | 15:30 to 22:30 | Banana Juice |
| [Server] | 15:30 to 22:30 | Beta David |
| [Server] | 15:30 to 22:30 | Delta Delta |
| [Server] | 15:30 to 22:30 | Happy Pasta |
| [Server] | 15:30 to 22:30 | Orange Bread |
| [Server] | 15:30 to 22:30 | Watermelon Sauce |
| [Support] | 16:00 to 22:15 | Pillar Concrete |
| [Support] | 16:00 to 22:30 | Hinge Joint |

---------------------------
---------------------------
SATURDAY

| | | |
|---|---|---|
| [Bar] | 15:15 to 23:00 | Fizzy Drink |
| [Bar] | 16:00 to 23:00 | Soda Pop |
| [Host] | 15:00 to 20:30 | Sit Here |
| [Host] | 16:30 to 22:30 | This Way |
| [Kitchen] | 10:30 to 16:30 | Apps Snacks |
| [Kitchen] | 10:30 to 16:30 | Napkin Cloth |
| [Kitchen] | 14:00 to 23:00 | Booth Train |
| [Kitchen] | 14:00 to 23:00 | Cake Pie |
| [Kitchen] | 14:00 to 23:00 | Fork Spoon |
| [Kitchen] | 14:00 to 23:00 | Plates Coy |
| [Kitchen] | 14:00 to 23:00 | Salad Greens |
| [Kitchen] | 14:00 to 23:00 | Sherbert Herbert |
| [Kitchen] | 14:00 to 23:00 | Tray Slip |
| [Kitchen] | 16:30 to 22:30 | Entree Meal |
| [Kitchen] | 16:30 to 22:30 | Knife Haver |
| [Manager] | 13:45 to 00:30 | Golf Cocktail |
| [Server] | 15:30 to 22:30 | Alpha Billy |
| [Server] | 15:30 to 22:30 | Apple Candy |
| [Server] | 15:30 to 22:30 | Beta David |
| [Server] | 15:30 to 22:30 | Delta Delta |
| [Server] | 15:30 to 22:30 | Gamma One |
| [Server] | 15:30 to 22:30 | Orange Bread |
| [Server] | 15:30 to 22:30 | Sad Potato |
| [Server] | 15:30 to 22:30 | Watermelon Sauce |
| [Support] | 16:00 to 22:30 | Pillar Concrete |
| [Support] | 16:00 to 22:30 | Rope Rigging |

---------------------------
---------------------------
SUNDAY

| | | |
|---|---|---|
| [Bar] | 15:30 to 23:00 | Fizzy Drink |

| | | |
|---|---|---|
| [Food Runner] | 16:00 to 22:00 | Rope Rigging |

| | | |
|---|---|---|
| [Host] | 15:30 to 21:30 | Sit Here |
| [Kitchen] | 14:00 to 23:00 | Booth Train |
| [Kitchen] | 14:00 to 23:00 | Entree Meal |
| [Kitchen] | 14:00 to 23:00 | Napkin Cloth |
| [Kitchen] | 14:00 to 23:00 | Sherbert Herbert |
| [Kitchen] | 14:00 to 23:00 | Tray Slip |
| [Manager] | 14:00 to 00:30 | Pointy Hair |
| [Server] | 15:30 to 22:30 | Alpha Billy |
| [Server] | 15:30 to 22:30 | Beta David |
| [Server] | 15:30 to 22:30 | Sad Potato |
| [Server] | 15:30 to 22:30 | Watermelon Sauce |
| [Support] | 16:00 to 22:30 | Glue Staple |

---------------------------

In the next step, the optimized schedule is converted into a machine-readable message and prepared for distribution. A report may accompany the optimized schedule to notify the recipient of any warnings or errors associated with optimized schedule. In certain embodiments, the message is pushed to an external message broker, for asynchronous consumption by the scheduling applications.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described in the application are to be taken as examples of embodiments. Components may be substituted for those illustrated and described in the application, parts and processes may be reversed, and certain features of the invention may be utilized independently, all as would be apparent to one skilled in the art after having the benefit of this description of the invention. Changes may be made in the elements described in the application without departing from the spirit and scope of the invention as described in the following claims.

What is claimed is:

1. A system for outputting an optimized schedule, the system comprising:
a processor; and
a memory storing a module with instruction executed by the processor, the processor operative to:
receive, via a user interface, a request for optimizing a schedule, the request including demand data;
partition the demand data to create daily shift configurations, each daily shift configuration including one or more duty period;
optimize the daily shift configurations by evaluating a fitness function for each daily shift configuration based on the demand data;
assemble the optimized daily shift configurations to produce one or more weekly shift configuration;
produce a plurality of assignment sets by randomly assigning one or more employees to the one or more duty periods of the weekly shift configuration;
calculate a fitness function for each assignment set based on one or more constraints associated with each employee and the demand data; and
generate an optimized schedule by performing a simulated annealing technique that iteratively alters each assignment set and evaluates the corresponding fitness function until a threshold is met, wherein the optimized schedule is output on a display device.

2. The system of claim 1, wherein the processor is further operative to validate a format of the request.

3. The system of claim 1, wherein said optimizing the daily shift configurations further includes cross-breeding two or more daily shift configurations.

4. The system of claim 1, wherein said optimizing the daily shift configurations further includes altering each shift configuration by at least one of modifying a start or end time of the duty period, reassigning the duty period to a different day, and changing a skill type associated with the duty period.

5. The system of claim 1, wherein said producing one or more weekly shift configuration further includes performing a simulated annealing technique that iteratively alters each daily shift configuration and evaluates the corresponding fitness function.

6. The system of claim 1, wherein the fitness function for each assignment set is represented as a 64-bit base-2 format double-precision floating point.

7. The system of claim 1, wherein said producing a plurality of assignment sets further includes cross-breeding two or more assignment sets.

8. The system of claim 1, wherein the processor is further operative to access a database including employee data corresponding to the one or more employees.

9. The system of claim 1, wherein said constraints associated with the demand data include at least one of a number of hours worked, a number of days worked, a number of unassigned shifts, a scheduling conflict, a position, and a location.

10. The system of claim 1, wherein said threshold is at least one of a number of iterations altering each assignment set, a desired fitness score for the schedule, and a minimum number of errors associated with the schedule.

11. The system of claim 1, wherein said processor is further operative to produce a report including warnings and errors associated with the optimized schedule.

12. A method for outputting an optimized schedule, the method comprising:
receiving, via a user interface, a request for optimizing a schedule, the request including demand data;
partitioning the demand data to create daily shift configurations, each daily shift configuration including one or more duty period;
optimizing the daily shift configurations by evaluating a fitness function for each daily shift configuration based on the demand data;
assembling the optimized daily shift configurations to produce one or more weekly shift configuration;
producing a plurality of assignment sets by randomly assigning one or more employees to the one or more duty periods of the weekly shift configuration;
calculating a fitness function for each assignment set based on one or more constraints associated with each employee and the demand data; and
generating an optimized schedule by performing a simulated annealing technique that iteratively alters each assignment set and evaluates the corresponding fitness function until a threshold is met, wherein the optimized schedule is output on a display device.

13. The method of claim 1, further comprising validating a format of the request.

14. The method of claim 1, wherein said optimizing the daily shift configurations further includes cross-breeding two or more daily shift configurations.

15. The method of claim 1, wherein said optimizing the daily shift configurations further includes altering each shift configuration by at least one of modifying a start or end time of the duty period, reassigning the duty period to a different day, and changing a skill type associated with the duty period.

16. The method of claim 1, wherein said producing one or more weekly shift configuration further includes performing a simulated annealing technique that iteratively alters each daily shift configuration and evaluates the corresponding fitness function.

17. The method of claim 1, further comprising accessing a database including employee data corresponding to the one or more employees.

18. The method of claim 1, wherein said constraints include at least one of a number of hours worked, a number of days worked, a number of unassigned shifts, a scheduling conflict, a position, and a location.

19. The method of claim 1, wherein said threshold is at least one of a number of iterations altering each assignment set, a desired fitness score for the schedule, and a minimum number of errors associated with the schedule.

20. The method of claim 1, further comprising preparing a report including warnings and errors associated with the optimized schedule.
